(19) United States
(12) Patent Application Publication
(10) Pub. No.: US 2021/0045412 A1
(43) Pub. Date: Feb. 18, 2021

(54) PREPARATION METHOD AND USE METHOD OF TEA DREG BEING DIRECTLY USED AS ADDITIVE THAT PROMOTES HEALTHY GROWTH OF ANIMAL

(71) Applicant: Xiuqin PAN, Shanghai (CN)

(72) Inventor: Xiuqin PAN, Shanghai (CN)

(21) Appl. No.: 16/964,996

(22) PCT Filed: Jan. 21, 2019
(86) PCT No.: PCT/CN2019/000010

§ 371 Date: Jul. 26, 2020

(30) Foreign Application Priority Data
Jan. 28, 2018 (CN) 201810117006.5

(51) Int. Cl. A23K 10/37; A23K 20/10; A23K 50/30; A23K 50/40; A23K 50/75

(52) U.S. Cl. CPC A23K 10/37; A23K 20/10; A23K 50/75; A23K 50/40; A23K 50/30

(57) ABSTRACT

Hormesis model (i.e. a toxicant excitation effect or a low dose promoting effect) is firstly used to study the relationship between the amount and efficacy of tea seed meal in feed industry. The amount of the tea seed meal as feed additive for the low dose promoting effect is determined to be 0.25-4 kg per ton of complete feed in the monogastric animal feed. The use method and the amount of the tea seed meal as feed additive can improve animal growth performance, such as increase daily weight gain, improve feed conversion ratio and decrease mortality.

### FIELD OF THE INVENTION

The invention belongs to the technical field of agricultural and application of sideline product and relates to a preparation method and a use method for directly serving Tea seed meal as an animal feed additive for promoting healthy growth of animals. The invention can be classified in the application of agricultural sideline product.

### BACKGROUND OF THE INVENTION

The present invention relates to the following description and explanation. If the terms used in this invention are conflicting with the industry term, the complete commonality or common part of this term in this invention is approved and accepted; if the definition of the industry term and the connotation are not clear or there is no standard consensus in feed industry, the following definitions are defined for the present invention. Also, definitions for the present invention are first interpreted in a broad or expanded manner unless otherwise indicated.

1). The Camellia oleifera is also referred to as the camellia tree (and refers to the Camellia Linnaeus). The seed oil content of the seeds in Linnaeus plants is high, the fruits are used for oil pressing, and the perennial trees or shrub trees with certain cultivation and operation areas are referred to collectively. The tea comprises the most widely distributed common Camellia oleifera, C. meiocarpa, C. reticles, Zhejiang safflower oil tea, C. yuhsiensis and C. views and the like, and also includes various camellia trees with ornamental and oil-producing dual functions.
2). The tea tree is also referred to as a tea tree. The camellia japonica Linnaeus Sinensis (Linnaeus). The Okuntze plant is characterized in that the leaves or buds can be directly brewed with boiled water after being properly processed; the tea comprises green tea (Longjing tea, pearl tea, Huanghua Hubeheng, Shengl plush, etc.). The tea is prepared from various kinds of tea trees such as black tea (black tea, Wuyi rock tea, impatiens monabietic tea and the like), white tea (white-silver needle tea, white peony tea, tribute tea, etc.), yellow tea (Mongolian yellow bud tea, Huoshan yellow bud tea, Kaffir kaffir tea and the like), black tea, Pu'er tea and the like.
3). The tea seed comprises camellia seed (also called camellia seed) and tea seed, and is seed of tea fruit; the tea seed shell (also referred to as the tea seed inner shell) in the tea seed accounts for ⅓ of the total weight of the tea seed, and the tea seed kernel (also called tea kernel) accounts for ⅔ of the weight
4). The tea outshell comprises a skin or a shell comprising camellia fruit (Camellia oleifera fruit) and tea seed fruit; the peel is in a flat circular shape or an olive shape.
5). The tealeaf seeds comprise the fruits of various tealeaf trees, tealeaf which are drunk in daily life, and the tealeaf seeds are by-products produced by tea leaf.
6). The tea oil is an oil product obtained by a method such as tea seed or Camellia oleifera seeds as raw materials, squeezing and or leaching and the like.
7). The cake is a by-product obtained after seed (like Camellia oleifera seed) mechanical physical squeezed; The meal is a byproduct obtained after the oil of seed is taken out by chemical solvent.
8). The Tea seed cake comprises the following raw materials: tea seeds or camellia seeds as raw materials, and by-products after oil pressing, the Tea seed cake has a cake shape and a flaky fraction.
9). Tea seed meal also referred to as tea bran or Tea seed cake or Tea seed meal in the published literature. The invention refers to the broad sense, which not only includes all kinds of byproducts after the extraction or taking out oil, but also includes the Tea seed cake in the term 8, because the cake can be pulverized into powder form, cake and powder form of Tea seed meal can be regarded as the same material. The method comprises the following steps: processing tea seed cakes, Camellia oleifera meal, tea seed meal and tea seed cakes, and is a total weight of solid leftovers after processing production of tea seeds, and belongs to a by-product; the tea seed cake is not processed by other processes; the tea seed cake is generally purple brown or light brown; the tea seed cake has a plurality of physical forms such as purple brown or light brown; the tea seed cake also comprises Camellia oleifera meal with some oil and oil-free Tea seed meal.
10). Tea saponin: also referred to as camellia saponin, is an uniform component of various kinds of saponin in Camellia camellia plants (including Camellia oleifera and tea trees, etc.), and belongs to the same mixture of oleanane type pentacyclic triterpenoid saponins similar to the main body structure; The tea saponin has bitter taste, can obviously stimulate the nasal mucosa, has the characteristics of hemolytic and the like, and is regarded as an anti-nutrition factor by some experts.
11). Tea polyphenol. Tea Polyphenls et al. refer to various parts derived from tea (leaf) trees and oil tea trees. The molecular structure of the tea polyphenol is the total weight of plant components including tannin, flavone and the like, and can be from tea leaves or Tea seed meal or tea Outshell and the like.
12). Tannin is also known as tannin and belongs to the scope of tea polyphenol. Tannin is a kind of phenolic compound with water solubility and molecular weight between 500 and 3000; the tannin can be divided into hydrolyzed tannin and condensed tannin according to the chemical structure; the condensed tannic acid is a flavanol derivative, and the 2 position of the flavanol in the molecule is combined with catechol or benzotriol through a carbon-carbon bond; and the tannic acid and the molecule have ester bonds and are gallic acid esters of glucose. The tannin is an active molecule with a negative charge and is easy to chemically react with a single positive charge protein in saliva (a hand-glove mode), so that the surface layer of the oral cavity generates a convergence feeling and the feeling is dry and astringent. Tannin in Tea seed meal is believed to be an anti-nutritional factor due to its astringent taste.
13). Procyanidine, ie, condensed tannin, are structurally combined by different numbers of catechins or epicatechin. The simple proanthocyanidins are catechins, or epicatechin, or dimers formed from epicatechin and epicatechin. According to the size of the polymerization degree, the two-pentamer is commonly referred to as an oligomer (OPC), and the pentamer is referred to as a high-polymer (PPC).
14). Flavonoid compounds: narrow sense refers to a class of compounds of which the parent nucleus is 2-phenylchromone, referred to as a flavonoid compound. The general formula is yellow, and the 4-position has a ketone-type carbonyl group, most of which is 2-phenylchromone (2-phenylchromone), namely flavone alcohol, and broadly refers to one type of component which is formed by connecting two benzene rings (A-ring and B-ring) through a three-carbon chain and is referred to as a flavonoid compound. Most of the basic framework has 6 C-3 C-6 C, and usually has substituent groups such as hydroxyl, methoxy, methyl, isoprene and the like. The flavonoid compounds in the present patent include the above two definitions.
15). The method for detecting the content of effective components in the Tea seed meal is preferably detected according to the following method if not special mentioned.
(1) Tea saponin is detected according to a weight method of ethanol extracted method or industry standard method China HG/T 4492-2013.
(2) Tannin content, according to China GB/T 15686-2008, or determined by the method of National Standard of edible tannin.
(3) Tea polyphenol detection is carried out according to China GB/T 8313-2008 method or other industry standard method. 16). Hormesis: a poison excitatory effect or a low dose promotion effect; a professional term is used to describe the toxicity factor. The dose-effect relationship model is neither a threshold model applied in traditional poison risk assessment nor a linear non-threshold model, but is also referred to as a linear non-threshold model, but can also be referred to as a U-type or J-type curve mode, i.e., a high dose toxic factor (such as a toxic substance) is harmful to organisms, and which is beneficial to organisms at low doses.

In China, the product of tea seed oil (Camellia oleifera) is about 0.5 million tons per year, By-product of tea oil, namely Tea seed meal is approximately 1.5 Million tons, 3 Million tons of tea Outshell. The Camellia oleifera mainly grow in the southern hilly mountainous area in China, and the amount of two byproducts for deep processing is small; The Tea seed meal is somewhat used for extracting tea saponin, and most of the tea seed outshell are used as fuel to burn off.

At the same time, tealeaves are produced in China, tea seeds can be produced at about 0.8 million tons per year, and the tea oil is about 100 thousand tons; and meanwhile, the produced tea seed cake meal is approximately 600-700 thousand tons; At the same time, tealeaf seed oil is also used as a new resource food for obtaining CFDA approval, and the amount of by-products of tealeaf seed oil become more and more.

In recent years, people pay more attention to the development of Camellia oleifera oil and tealeaf seed oil, and at the same time, the development and utilization of the two kinds of Tea seed meal are also increased. From two types of Tea seed meal components, various components such as about 12-18% of crude protein, 30% of total sugar, mineral elements and the like are contained, and the Tea seed meal should be used as a feed raw material, but due to the fact that the Tea seed meal usually contains 10-18% of tea saponin, 2% of tannin (tea polyphenol), 1.5-3% of alkaloids, 0.2% of flavone and about 30% of cellulose, has strong irritation and spicy bitterness, and is extremely poor in palatability; in particular, tea saponin and tannin are considered as anti-nutritional factors by some experts. Therefore, in the feed industry, most of the technical personnel are generally considered to be capable of solving the problem of detoxification firstly, namely removing toxin or detoxicating tea seed meal after tea saponin and tannin and other anti-nutritional factors are removed, and then the Tea seed meal can be used to supplement in the feed. Title of “Experiment of feeding pig with the Camellia oleifera meal (tea seed cake) after removing toxicity” published in the 4th of 1987 in Chinese animal husbandry journal, and the paper published by Diaohuang with title development progress of improve feeding quality of Camellia seed meal by the microbial fermentation method in 2014.

The method for detoxification of Tea seed meal currently has a pit burying fermentation method, an alkali detoxification method, a water extraction method and a solvent method. The method comprises the following steps: pit-burying fermentation detoxification is adopted, pit digging and sealing are needed, and relatively long time is needed; a base solution needs to be added, boiling, filtering, drying and alkali detoxification methods are needed to destroy protein; a water extraction method needs to add hot water, heat preservation and centrifugal filtration to remove a solution, repeatedly leach and dry; the tea saponin is extracted through a solvent method, so that Tea seed meal needs to be crushed, added into ethanol and the like repeatedly, and the tea saponin is further dried. In addition, the method is not perfect, and some methods are tedious and time-consuming and poor in effect. At present, the method is only a small test or a pilot plant stage, does not realize large-scale industrial production, and is not widely popularized and applied.

The preparation method of the biological enzyme-rich tea seed meal fermented feed disclosed by the application No. CN103211084, entitled “Bio-Enzyme-RichTea seed meal Fermentation Feed”, filed on Apr. 17, 2013, by Anhui Agricultural University, is disclosed in Patent Application Publication No. CN103211084, filed on Apr. 17, 2013. The invention discloses high-quality Tea seed meal for feed addition and a preparation method thereof. The high-quality Tea seed meal for feed addition and the preparation method thereof have the advantages that the Tea seed meal is fermented by using a mixed strain (bacillus subtilis, lactic acid bacteria, saccharomycetes and actinomycetes) The preparation method comprises the following steps: preparing fat pig feed auxiliary materials by using Camellia oleifera meal by utilizing the patent publication number CN06858114A on Apr. 21, 2017; and fermenting the Tea seed meal by using Bacillus subtilis in the preparation of the fat pig feed auxiliary materials by using Camellia oleifera meal.

Most of the Tea seed meal is still used as an organic fertilizer, a fishpond cleaning agent or fuel; some Tea seed meal is used as raw material for extracting high-puried tea saponin for washing, pesticide, building material, mining and other industries.

The prior art closest to the present invention is as follows:

The Chinese patent ZL96193005.5 of Zhejiang University, entitled “Feed Composition Containing Triterpenoid Saponin Extract and Nutritional Health Care Agent” from Camellia Plant Seed Oil Oil Residue (Camellia oleifera Cake Meal). The tea saponin (triterpenoid saponin) is extracted, and used as feed additive, but ethanol in this invention is continuously used for extracting three times of Tea seed meal. The tea saponin is repeatedly extracted, the cost of purified tea saponin production is high, the consumed time in this invention is long, and the ethanol belongs to flammable and explosive articles, and the method is some danger, and which also cause waste of other effective components. In addition, the residual amount is large, the drying is difficult, the cost of purified tea saponin is high, and the price of purified tea saponin is expensive; and the product of purified tea saponin yield and the sales volume of the technical scheme are small.

China Patent 2009100746177 entitled “Production Method of Multi-Effect Oil Tea seed cake Meal Feed Additive” by using Chinese Patent 2009100746177 entitled “Multi-Effect Oil Tea Seed cake/meal Powder Feed Additive”, but still has the following disadvantages: the superfine crushing cell wall is adopted, then water is added for ultrasonic pulverization, and finally, the method is complex and tedious production process of spray drying and the like. In the production process of the tea oil, the wall of the cell can be destroyed by adopting a manner of heating and cooking Camellia seeds and the like, so that the plant cell wall breaking degree is sufficient to release the soluble active substances such as tea saponin, tannin and the like, so that time and labor are not needed, and the wall is broken.

According to the Tea seed meal produced by the method, the tea saponin content in Tea seed meal is unchanged, and the amount of Tea seed meal is 2% in animal feed, so that the tea saponin dosage is up to 2000-3000 ppm (calculated as tea saponin at least contained in the Tea seed meal). According to the feeding test in the patent literature, the dosage of the first group of Tantieshu is 2500 ppm, the Tantieshu contains 30% tea saponin (Camellia oleifera saponin), that is, the dosage of the first group of tea saponin is only 750 ppm, and the food intake is obviously influenced. The tea saponin dosage of the second group reaches 2000-3000 ppm, the special spicy stimulation of tea saponin and the bitterness of tannin still exist, the feed intake can be significantly reduced, and the tea saponin can be obviously reduced due to the fact that the tea oil contains 3-7% of tea oil, has excellent fragrance and phagostimulant effects, or other test errors, and causes the food intake to be reduced; Meanwhile, the test also does not set up a blank control group, and is not continuously fed on the same day or trims; therefore, the logic analysis and the precedent defect angle on the test design are judged from the logic analysis and test design with high tea saponin content, and the feed intake test data result is obviously suspected.

The Tea seed cake contains the following components in percentage by weight: 3-7% of residual oil, and more expensive selling price; the Tea seed cake is usually obtained by some large-scale oil plants, and then the Tea seed cake is subjected to secondary oil extraction by using a chemical leaching method, so that the commercial vast majority of Tea seed meal is not oil-free (about 0.5%).) Due to the fact that a husking machine is adopted for removing the inner shell of the tea seeds, due to the fact that the size of the tea seeds is different, the performance difference of the husking machine is different, the shelling rate is unstable, a certain degree of damage is caused, and the total shell-free Tea seed meal is very few.

According to the method, Tea seed meal is processed, and the tea saponin content is still 10-18%; according to the addition of 2%, the food intake of the animal can still be obviously reduced or eaten; and in addition, the steps are complex, the cost is remarkably increased, and on the basis of the above reasons, the patent has no application and popularization in practice, and is currently in an invalid state.

Three: Sun yanfa et al. “Feed Research” 2016 (19) 32-37, the article of preparation method comprises the following steps of: adding tea seed cake meal to feed has the effects of improving the production performance, the immune function and the anti-oxidation function of the broiler chicken, and attempts to directly use the tea seed meal for the feed; The final conclusion of the article is that the proper addition amount of the Tea seedcake/meal in the broiler feed is 0.5%, before the broiler is 21 days; and the expression in the article abstract is that the test result shows that compared with the control group, 0.50% of tea seed cake meal is added to the daily ration without significant influence on the growth performance of the broiler chicken (P>0.05). The disease death rate (P<0.05) of the 14-D broiler chicken can be significantly reduced. In practice, compared with the control group, the daily gain is not increased, and the FCR is obviously reduced, so that the use amount of the 0.5% Tea seed meal in feed leads to poor growth performance, and the dosage is obviously failed and side-effect.

Meanwhile, the test data show that the death rate of the other four groups of 14 days is 0, and the disease death rate of the 0.5% Tea seed meal group is 3.33%+/−7.45% (the data is suspected, and further verification is needed), and the conclusion that the death rate of the other four groups is inconsistent with the conclusion that the death rate of the disease is reduced is inconsistent.

Tests show that when the adding amount of the Tea seed meal reaches 0.75% and 1%, the Tea seed meal has obvious side effects on the growth performance, the feed intake is reduced, and the FCR is poor.

Specifically, the content of tea saponin in the test product is 18%, but the detection method is not noted; the usage amount of 0.5% is 5 kg per ton of feed, and the dosage of the tea saponin reaches 900 ppm; however, the dosage does not cause the daily feed intake to be reduced, but is slightly increased by 77.13 and 75.6 g/day.) The method comprises the following steps of: adding 200-500 mg/kg (ppm) of tea saponin to reduce the average daily eating amount of (broilers) by adding 200-500 mg/kg (ppm) of tea saponin, so as to obviously contradict; therefore, it is concluded that 0.5% of the Tea seed meal dosage group does not reduce the feed intake of the broiler chicken.

If the feed intake of the broilers is 5-6% of the weight, the amount of tea saponin in the feed is calculated to be 900 ppm; and the actual usage amount is as follows: the intake amount of tea saponin reaches 54-45 mg/kg (body weight)) In one step, the tea saponin content in the Tea seed meal in the test is considered to be only 15% (18% may be high), and the actual usage amount is 37.5-45 mg/kg (body weight)/day; compared with the test dosage or the recommended amount upper limit in other documents, the dosage is also obviously higher.

In summary, 0.5% of Tea seed meal is added into the broiler feed, to promote growth to be ineffective, and instead, the FCR is poor, and the conclusion is that proper addition amount of the Tea seed meal in the broiler feed is 0.5%; which is obviously wrong.

So far, in the list of feed raw material directories and feed additive directories which are allowed to be used by the feed, none of the tea seed meal are found to be listed therein; this is likely to be related to the technical prejudice commonly found in the feed industry, that is, the Tea seed meal has strong irritation and spicy bitterness (commonly known as toxic).) The Tea seed meal is not directly used for the feed. If the Tea seed meal is to be used, the problem of detoxification or detoxification is solved first. Due to the two reasons, the Tea seed meal does not need to be used as a directory. Meanwhile, the Tea seed meal is not stored in the drug feed additive variety catalog, ie, any form of Tea seed meal is not stored in the feed to allow legal use in the directory.

Different processes and methods are adopted, various active substances such as tea saponin, tea polyphenol or tannin, flavonoid compounds, tea seed polysaccharide, tea seed protein and the like are extracted from the Tea seed meal, a lot of technical articles are published, and a lot of the patent is applied. The invention discloses an extraction method of high-purity tea saponin, which is applied on Aug. 20, 2017, and discloses a rapid preparation method of flavone glycoside in Camellia oleifera meal, which is applied to Jan. 18, 2016

Due to the fact that the Tea seed meal is considered to be low-grade agricultural and sideline products, the Tea seed meal has not been approved as new resource food, food additive, health-care food raw material or food with the same source as a new resource food, a food additive, a health-care food raw material or a food with the same source as a new resource food, a food additive, a health-care food raw material or a food and medicine co-source food at present, i.e., the Tea seed meal is generally considered to be suitable for eating.

In addition, the Tea seed meal is an agricultural and sideline product of an edible oil plant, and it is not on the blacklist list, which lists all kinds of prohibited products.

### SUMMARY OF THE INVENTION

The invention provides a preparation method and an use method of the Tea seed meal directly as an additive for promoting healthy growth of animals.

The preparation method comprises the following steps: firstly, carrying out detailed introduction on several main active ingredients of the Tea seed meal in the invention:

The first main active ingredient is tea saponin. In the literature, the content of tea saponin in Tea seed meal is 10-15%, and some are 12-18%; The difference is related to the raw material production area and the processing technology; on the other hand, the detection value of the tea saponin extracted by the ethanol method is higher than the detection value extracted by the n-butanol; because the ethanol extraction also contains other components such as flavone, tannin or alkaloid, and the n-butanol extract is mainly tea saponin. The tea seed meal is high in tea saponin content, relatively strong in bitter taste and easy to stimulate the nasal mucosa to cause sneezing; the palatability is poor, and the hygroscopicity is high.

The tea saponin is a natural non-ionic surfactant, has a good emulsifying effect and a foaming capacity, and has the effects of killing bacteria, diminishing inflammation, relieving pain, resisting seepage and the like of the natural non-ionic surfactant, and has the effects of sterilizing, diminishing inflammation, relieving pain, resisting seepage and the like.

It is also mentioned that tea saponin can stimulate secretion of hormone in animal body, such as adrenal gland and hormone (corticosteroid). Since the corticosterone has strong metabolic effect on sugar, the sugar element can promote the generation of sugar and glucose and inhibit the utilization of blood sugar, so that the blood glucose can be temporarily increased. The tea saponin can also reduce the cholesterol level in the liver and serum, so that the tea saponin has the effect of reducing blood fat.

The biological activity of the tea saponin and the application research progress of the tea saponin in animal production are all mentioned, and the tea saponin has the effects of enhancing immunity and resisting oxidation.

The second active ingredient is tannin which comprises tea polyphenol. The content of tannin in the Tea seed meal is about 2%, and the individual literature refers to the content of 6-7%; The taste of the Tea seed meal is astringent, and tannin in Tea seed meal is regarded as an anti-nutrition factor by some experts; however, the tannin polyphenol hydroxyl chemical structure and the unique chemical property make the tannin to exhibit strong oxidation resistance. In addition, although tannin can be bonded with saccharides, amino acids, proteins, iron ions and the like in the feed, the binding is reversible and is extremely easy to be separated in an acidic environment. Tannin has been approved as a food additive; plant tannin is generally considered safe. Tannin also belongs to the scope of tea polyphenol, and tea polyphenol has been listed in China national standard GB2760-2007 “Food Additive Using Sanitary Standard.” The main function is antioxidant. The invention discloses various effects of inhibiting bacteria, resisting viruses, resisting cardiovascular and cerebrovascular diseases and the like of Camellia oleifera tannin The food has the effects of natural antibacterial and anti-corrosion in the food field, can be used as a stabilizer in a liquid beverage, and can also be used as a raw material of the health-care food.

Third active ingredient is flavonoid. The content of flavone in the Tea seed meal is reported to be about 0.2%, and some published paper mentioned that the content of flavone in the Tea seed meal is 1.3%, which can be closely related to the detection method. Meanwhile, the disclosure shows that the flavonoid compound in the Tea seed meal is mainly kaempferol, naringenin and derivatives thereof and the like. The paper of title “Separation and structure identification of flavonoid glycoside compounds in Camellia oleifera cake meal” was published on 2011 Journel “Forest Production Chemistry and Industry,” by Chen hongxia et al, The flavonoid glycoside in the oil-Tea seed cake meal is mainly kaempferol 3-O-[2-O-beta-D-galactose-6-O-alpha-L-rhamnose]-beta-D-glucoside and is kaempferol 3-O-[2-O-beta-D-xylose-6-O-alpha-L-rhamnose]-beta-D-glucoside.

Jiang heyuan published a paper on “Tea leaf Science” in 2005 mentioned that flavonoid glycosides in the tea seed cake/meal mainly comprises two kinds of kaempferol-3-O-rutinoside and kaempferol-3-O-(6-O-beta-D-glucopyranosyl)-beta-D-galactoside

At the same time, in the literature of CN101899070B, “A METHOD FOR RAPIDLY PREPARING FLAVONE FROM TEA SEED CAKE,” and China patent application number CN201610027047.6 “A METHOD FOR RAPID PREPARATION OF FLAVONES IN CAMELLIA OIL MEAL”, the Tea seed meal also contains flavonoid natural active ingredients, has the effects of resisting inflammation, resisting oxidation, resisting female hormone-like effects, resisting bacteria, resisting viruses and the like, and can diastole and protect the heart and brain; Various physiological activities such as memory, antidepressant anxiety, nerve protection and the like are improved, and the some flavonoid has been developed into novel plant drugs, such as ginkgo total flavonoids and the like, and has the effect of relieving liver toxicity.

Fourth active ingredient is ceramide. In addition, Japanese Patent JP2004189 China Authorization Patent CN102058727B “a tea seed extract containing ceramide and preparation method therefor”. The invention also discloses a natural ceramide, It is mentioned that ceramide is a two-molecule lipid layer component, and belongs to one of lipid-like structural units of sphingomyelin, and has important biological effects, such as messenger action and cell apoptosis, and has certain functions in regulation of cell apoptosis, cell differentiation, transfer, proliferation and the like. It is also believed to play a role in such processes as controlling cancer, neurasthenia, diabetes, obesity, inflammation and the like.

The fifth active ingredient is alkaloid such as caffeine. The Tea seed meal contains approximately 1% of caffeine, and belongs to xanthine alkaloid compounds; the Tea seed meal contains about 1.5-3% of alkaloid, which containing nitrogen (nitrogen-containing alkaline organic compound, most complex cyclic structure and nitrogen contained in the ring), and the biological activity can be the same as other natural nitrogen-containing organic compounds (such as vitamin B1), and has several physiological effects. The alkaloid has bitter taste, such as caffeine, and is also a central nervous stimulant and an appropriate amount of intake is extremely beneficial. In addition, the tea seed meal also has about 12-18% of protein, about 30% of polysaccharide, and beneficial trace mineral elements.

Technical prejudice exist in the feed industry because the Tea seed meal has strong irritation and spicy bitterness, the palatability is extremely poor, and the feed intake of Tea seed meal by animals is influenced, and even the animal reject to eat (which is commonly known as toxic.). Due to the fact that the Tea seed meal cannot be directly used for feed, the Tea seed meal can be used in the feed only after detoxification; at the same time, the technical prejudice of Tea seed meal have been guided to develop various processes to remove toxin or detoxify or reduce toxicity of Tea seed meal

Although the tea seed cake meal is added to the daily ration in articles published by Sun yanfa et al., The title is Tea seed meal added in the broiler feed, the effects of the tea seed cake/meal on the production performance, the immune function and the anti-oxidation function of the broiler chicken. But the addition amount of the conclusion of Tea seed meal in broiler feed is 0.5%, the daily gain of this dosage is not improved, and the FCR is poor; The addition of 0.75% and 1% of Tea seed meal is more obvious wrong, the daily gain of Chicken is reduced, and the FCR is worse, which is an actual example of the toxicity of the Tea seed meal; even if 0.5% of the added Tea seed meal in feed has no significant benefit, this is a typical failure case.

At present, no any paper reported that Tea seed meal crushed (not subjected to any extraction or deep processing for non-toxic or non-toxic or detoxification) is added directly into the livestock feed for use, and an active effect such as growth promotion and the like.

The technical problem to be solved by the invention is that the Tea seed meal has spicy and bitter taste, is extremely poor in palatability (commonly known as toxic) and cannot be directly used in the feed.

According to the technical scheme of the invention, the Tea seed meal is scientifically researched and judged in the feed industry for the first time in the feed industry, so that the relation between the dosage and the efficacy of the Tea seed meal is accurately analyzed; the dosage range of the low-dose promotion effect of the Tea seed meal in the feed is preliminarily determined to be 250 grams to 4 kilograms per ton of the completed feed.

The use amount of the Tea seed meal in each ton of complete feed is controlled to be within a reasonable range of 250 grams to 4 kg, and the problem is solved; preferably, 0.5-2 kg, most preferably 0.8-1 kg; the above usage amount of the Tea seed meal in animal feed, the growth performance of animals can be improved, the FCR is improved, and the death rate is reduced.

The details of the invention are set forth in the drawing and the description below. Other features, objects, and advantages of the invention will be apparent to those persons skilled in the art upon reading the drawing and the description, as well as from the appended claims.

### DETAILED DESCRIPTION

A large number of literature, combined with working experience, several points of the invention are summarized as follows:

First Part, there are four possible main reasons of technical prejudice against Tea seed meal in the feed industry.
1. The Tea seed meal is generally considered to be the agricultural and sideline products with certain toxicity and is not suitable for being directly used in the feed; the understanding is based on the existing experience and animal test cases, and indeed, the understanding and understanding of the so-called toxic are general and fuzzy, and still stay in toxic and non-toxic traditional cognitive stages. According to the traditional poison risk model, the toxicity of the Tea seed meal is indeed possible to belong to a threshold model instead of a linear non-threshold model. Because the feed industry technician has little knowledge and accurate cognition on the Hormesis model, scientific judgment cannot be carried out; therefore, it is difficult to identify the toxicity model of the Tea seed meal from another angle (such as improving the growth performance of the animals), and can also belong to the Hormesis model, namely the dual-phase dose effect model.
2. In addition, the Tea seed meal is generally considered to be toxic and cannot be directly used by people in the feed industry; and the main reason is that tea seed meal is used as feed raw materials. The deep analysis is as follows: 1). The Tea seed meal, the soybean meal, the rapeseed meal and the like are all by-products of an edible oil plant; 2) All meal byproduct of plant oil contain high level of crude proteins, 3) The price of the Tea seed meal is cheaper, only about 2000 RMB per ton, and is easy to be purchased; therefore, a person skilled in the feed industry is easy to treat it as a feed raw material, and once it is used as a feed raw material, the dosage of the starting point is 1-3%, that is, 10-30 kg of Tea seed meal is added per ton feed, and at least 5 kg of per ton feed (such as 0.5%, 0.75 and 1%); and if Tea seed meal as feed raw materials, which is not detoxicated in advance, there is a significant side effect when Tea seed meal used as feed raw material, such as significant reduction in feed intake, slower growth of animal, that is, the commonly-known Tea seed meal is toxic, and meanings Tea seed meal cannot be used in the feed directly at all.
3. Tea seed meal cannot be directly used in animal feed, but a person skilled in the art tends to remember that the price of the Tea seed meal is cheap, the content of crude protein is high, and the Tea seed meal is easy to be purchased. Therefore, a person skilled mostly try to make Tea seed meal detoxified or attenuated (because of the anti-nutritional factors such as tea saponin, tannin and the like, e.g., remove tea saponin or fermentation detoxified), then the detoxified Tea seed meal can be used to instead of other more expensive feed raw materials (like soybean meal) in feed, so that the cost is reduced. The detoxified Tea seed meal used as a feed raw material and the detoxified Tea seed meal can be added in the feed about 5-10%, and allowed more amounts added in the feed, the animal test effect of this method can be accepted, the cost can be reduced, and therefore, the method has a certain market. In particular, after tea saponin (high added value) is extracted, residual (detoxification) is carried out, The sale price of the detoxified Tea seed meal is still approximately 2000 RMB per ton. and The price gap between Tea seed meal and detoxificated Tea seed meal is small and not obvious; the factory of Tea seed meal has more driving force and enthusiasm to extract tea saponin with high added value, so that the Tea seed meal becomes two types of products, namely tea saponin and detoxificated Tea seed meal, the economic benefit is obviously increased, the manufacturer disputes and emulates, a large amount of detoxified Tea seed meal (i.e., the residue after tea saponin extracted) is marketed and used as a feed raw material, the problem of Tea seed meal used in feed is solved in a certain extent, and the problem of Tea seed meal used in feed is no longer urgent.
4. In addition, from the view of price, the Tea seed meal is very cheap, is only 2000 RMB per ton, which is cheaper than the raw materials, such as soybean meal and the like; therefore, the Tea seed meal is classified into raw materials, such as soybean meal, rapeseed meal and the like; in fact, on the large premise, the functional positioning of the Tea seed meal is wrong, and the Tea seed meal should not be taken/classified as a feed raw material; The function position and classification of Tea seed meal is wrong, and the usage method of Tea seed meal is naturally prone to one error.

Second Part, a three-pronged analysis reveals comprehensively the prejudice against the Tea seed meal in the feed industry:
1. A deep and careful analyses of the Tea seed meal determines a plurality of unique active ingredient characteristics contained in the Tea seed meal, corresponding effective content characteristics and efficacy characteristics (such as sterilization, bacteriostasis, anti-inflammation, oxidation resistance, immunity improvement and the like.). The three features are completely more consistent with the main technical features of the feed additive; although according to several surface features of the Tea seed meal (meal, by-products of the edible oil plant, more crude protein is contained, the price is also low.) The Tea seed meal is classified as a feed raw material class and it is also reasonable; however, comprehensive evaluation is carried out, and the functional feed additive class is preferred according to the main salient characteristics and the comparison advantages of the Tea seed meal, instead of the feed raw material class, and is more suitable. Tea seed meal should not be fuzzy positioning and wrong positioning.
2. From the view of Inner essence and active ingredients content of The Tea seed meal, which has the effects of sterilizing and inhibiting bacteria, diminishing inflammation, killing viruses, resisting oxidation and improving immunity. From the view of practical application effect of the patent, the Tea seed meal does have the effect of promoting the growth of livestock and poultry, increasing the daily gain, improving the FCR, and reducing the death rate of the disease; therefore, the Tea seed meal is a remarkable and plant source feed additive, can partially replace or completely replace antibiotic growth promoter (AGP) and other planting feed additive in the market, and the Tea seed meal is a real cheap and green feed additive.
3. A deeply understanding of the toxic excitement effect (Hormesis) is needed. After the Hormesis model is analyzed, after the main action mechanism of the active ingredients in the Tea seed meal is analyzed, the majority of tea saponin is not absorbed by the intestinal tract, mainly acts on the surface of the cell membrane, enhances the permeability of the cell membrane, and promotes the absorption of nutrient substances. After actual working experience, it is confirmed that the toxicity model of the Tea seed meal in animal feed is a Hormesis model, which is also referred to as a biphasic dose effect model, that is, when a high dose (as in the broilers trial reported by Sun yanfa), namely the use amount of the Tea seed meal in feed is 0.5%, 0.75%, 1%) is harmful to the organism/animal, and the low dose (as in the embodiment of the present patent) is 0.025%-0.4% is beneficial. The relationship of effect and amount of such poison material is also referred to as a U-type curve or a low dose promotion effect mode. The invention needs to protect the claim that Tea seed meal as feed additive and the dosage range of the Tea seed meal in feed, low-dose promotion Effect, that is, the range of the Lowest effective dose of the theoretical Lowest effective dose (NOAEL) to the non-visible harmful dose (NOAEL), which is equivalent to namely dosage range is 250 grams to 4 kilograms of the Tea seed meal added/supplemented per ton animal feed in the patent.

Third part: ten points of the principles of the invention and the key points of the invention are summarized as follows:
1. Three technical features are summarized from the comparison advantages of Tea seed meal (common Tea seed meal containing 15% of tea saponin, and about 2% of tannin), namely rich and diverse active ingredient characteristics, effective content characteristics and actual efficacy characteristics, and it is determined that the Tea seed meal should be preferred as a functional feed additive, and the Tea seed meal should not be attributed to feed raw materials.
2. The tea seed meal is a treasure, and contains various natural active ingredients, such as tea saponin, and the tea polyphenol comprises tannin (proanthocyanidins)) flavone, ceramide, caffeine alkaloid and the like, and is rich in variety and high in content; the unique active components are naturally gathered together and possibly have the synergistic effect for animal natural growth, and the Tea seed meal do not need to be extracted or extracted with an organic solvent at all; the active ingredients in Tea seed meal are difficult to completely extract through a solvent; some of the active ingredients are reduced or lost completely in the extraction process. The Tea seed meal is directly added to the feed for use, all activity and nutrition are achieved, no ingredient loss or activity is reduced, all the effective components are fully utilized, and the unique biological activity is exerted.
3. According to the invention, it is believed that the main active ingredient is tea saponin in the Tea seed meal, tea saponin is excellent in non-ionic surface active agent, has a hydrophilic group and an oleophilic group, and has good stability; Tea saponin does not need to be absorbed into intestinal cells to play a role; (1) The tea saponin plays an active role in the intestinal cavity, has a very strong and stable emulsification effect and can promote digestion and absorption of grease; (2) Tea saponin can be combined with cholesterol on intestinal cell mucosa, activate the cell lipid raft, enhance the permeability of the cell membrane and promote the absorption of intestinal cells to nutrient substances; and (3) Tea saponin can activate intestinal immune related cells, particularly APC cells, macrophages T cells and the like, and enhance the immune response reaction.
4. Due to the fact that the tea saponin in the Tea seed meal is taken orally, the tea saponin in the Tea seed meal is not absorbed by the intestinal tract, and the tea saponin is discharged out of the body; therefore, after the corresponding sufficient effective dose of tea saponin is reached, the tea saponin is additionally added without a plurality of benefits, and a certain side effect is caused, such as the feed intake of the animal is decreased, and the intestinal cell mucosa is damaged; therefore, control the use amount of Tea seed meal in animal feed is very important.
5. The following is to accurately recognize and scientifically apply the poison excitation effect model (dual-phase dose effect model or U-shaped mode) of the Tea seed meal In the case of high dose, which is harmful to organisms, while low dose is beneficial to organisms; in combination with animal trial results of related Tea seed meal, scientific analysis, comprehensive research and judgment: the lowest effective dose (LOEL, Lowest Observed Effect Level), the Maximum Response Level (MRL), No observed effect level (NOEL) and the proportional relationship between the three dosage values. The average of NOAEL values is about 10-20 times the LOEL value; the Maximum Response Level average is about one-fifth of the NOAEL value.
6. The method described here comprises the following steps: comprehensively considering the content of active ingredients in the Tea seed meal, the use amount of the Tea seed meal in the feed, and the dialectical relationship among the use effects; scientifically and reasonably formulating the quality standard of the Tea seed meal product, and standardizing the usage amount and efficacy of the recommended usage in the feed.
7. Different tea seed varieties, different origin sources, different processing technologies and various active ingredients in the Tea seed meal are fluctuation and difference. In order to avoid the high level of effective component concentration in the finished product due to fluctuation of the raw material quality, scientific optimization matching of high and low raw materials can be carried out on the basis of detecting the quality standard of the product after each batch of raw materials is detected, so that the content of effective active ingredients in the semi-finished product is stable, the quality of the finished product is reliable, the carrier/excipient can also be selected for proportioning, and the standardization of the product is facilitated.
8. The key points of the invention are the prejudice that the technical bias of tea seed meal is corrected, that is, the Tea seed meal is toxic and cannot be directly used in the feed; meanwhile, the Tea seed meal is accurately positioned as a functional feed additive, and the protein in the Tea seed meal is not taken as a feed raw material; in the feed industry, a poison excitation effect model (double-phase dose effect model) is adopted for the Tea seed meal for the first time). The Tea seed meal can be accurately analyzed, and the relationship between the effective component content (such as the tea saponin content in the common Tea seed meal is about 15%), the different usage doses and the actual functional effect are accurately analyzed; the range of low-dosage use of the Tea seed meal in the complete feed for livestock and poultry is preliminarily determined to be 250 grams to 4 kilograms per ton feed.
9. According to the invention, the standard content of effective components in the Tea seed meal is scientifically set, the use amount is accurately and reasonably recommended, and the effect can be expected to be realized; the use safety of the Tea seed meal is safe, convenient and efficient, and all the effects of the Tea seed meal are fully exerted to a great extent; meanwhile, the product quality is kept stable and does not fluctuate; meanwhile, the production of the product can be standardized, specialized, large-scale and industrialized.
10. The Tea seed meal functional feed additive has extremely high practicability, and is very beneficial to realizing the upgrading and updating of the Tea seed meal industry; the Tea seed meal functional feed additive is accurately positioned, and the added value of the Tea seed meal functional feed additive is rapidly improved; the later Tea seed meal direct food additive, the Tea seed meal health product and the like are greatly facilitated; the practical application experience is laid for making a strong tea seed meal industry chain, and the practical application experience is laid for making the strong Tea seed meal industry chain.

Supplemental Description: A plan after patent application file publication or patent granted authorization.

It is intended to apply for product registration or apply for listed in approved feed additives catalogues after the patent got some protection. The patent of the invention is to push and promote the progress of the entire science and technology, and has certain advantages and leading properties. The product, tea seed meal (including the technical scheme or the use scheme) of the invention is not approved as feed additive by official or not in the allowed directory, and it can be completely understood.

Under the premise of certain rights protection, various materials and reports will be prepared actively and submit files to administrative department for allow the use of tea seed meal as feed additive or obtain the license of feed additive by administrative permissions; and then actual investment is carried out (authorized production and or sales).

Followings are 6 technical advantages and technical effects of the invention.
1. The Tea seed meal is easily sourced, and can be produced rapidly; meanwhile, by-products of the vast tea farmers are efficiently utilized, the demand of tea seed meal in feed industry is larger, the Tea seed meal can be better sold to feed mill, meanwhile, the price of tea seed meal can be increased, and the income of tea growers can be improved.
2. The processing cost of the Tea seed meal powder is low or the zero cost. Some manufacturers of tea seed meal themselves produce the tea seed meal fine powder, only needs to be simply replaced into a feed grade label, and can be directly sold, and the technical scheme provided by the invention has almost zero cost. If the Tea seed cake/meal or the coarse grain Tea seed meal is processed into the tea seed meal fine powder, the production method is simple, zero emission in the production process is realized, and pollution is avoided; the Tea seed meal is fully utilized; only the common pulverizer is required to be crushed and cost of processed is low (about 80-200 RMB of crushing cost per ton), and almost no threshold, and is easy to learn and easy to popularize. The Tea seed meal is sold and used according to the feed additive in the feed, that is, the application of the Tea seed meal is expanded or changed, and the user/customer number is violently increased; the Tea seed meal directly as feed additive, which is an ingenious innovation; therefore, the amount of the Tea seed meal direct sold to the feed industry is increased, and the economic benefit of the manufacturer is obviously increased.
3. The method is convenient to use and low in use cost. The Tea seed meal product is directly added in the feed, does not need to be detoxified, can be directly low in dosage for a long time (e g, 1-2 kg per ton), is simple and convenient, is low in use cost (about 2-4 RMB per ton of cost), and has a remarkable disease-resistant growth-promoting effect and an exact effect. At the same time, other planting feed additives with more expensive price can be partially or completely replaced, so that the cost can be obviously saved; meanwhile, the use of growth-promoting antibiotics can be partially or completely replaced, and the residue and the pollution of antibiotics are reduced.
4. The Tea seed meal product can be widely used in animal feed, can be used for a long time, and has no pollution to the environment.
5. The Tea seed meal product has the effects of resisting bacteria, preventing diseases and promoting growth, and also has the effects of diminishing inflammation, resisting oxidation and enhancing the immunity of animals; the Tea seed meal product is purely natural and pollution-free, and is an extremely-promising alternative growth-promoting green product. According to the technical scheme of the invention, the technical scheme of the invention has the benefits that the multi-party benefits, the Tea seed meal manufacturer or the customer (feedmill or farm of raising animal) are easy to adopt, the technical scheme of the invention will bring many benefit for the multiple parties, therefore, large-area popularization and common use are easily obtained, and good economic benefits, ecological benefits and social benefits are achieved.
6. The invention scientifically and simply solves the technical problem of how to use Tea seed meal in feed. In the range of the recommended dosage of Tea seed meal as feed additive, tea seed meal can promote growth in livestock and poultry, the ADG (average daily gain) increased, the FCR improved, and the disease death rate reduced; meanwhile, the toxic and side effects of the Tea seed meal on livestock and poultry do not need to be worried.

The specific technical scheme of the invention is as follows (a preparation method and a use method):

The preparation method of the Tea seed meal product comprises the following steps:
1. The preparation method comprises the following steps: purchasing various kinds of Tea seed meal (including cakes, pieces, and particles), removing foreign matter, drying in the sun or by drying machine.
2. The preparation method comprises the following steps: carrying out mechanical crushing on the raw materials at room temperature, and crushing the raw materials into about 80-150 meshes;
3. The content of tea saponin and the content of tannin (the tea polyphenol) are detected according to the ethanol extraction weight method and recorded; different quality standards of the product (such as, no less than 15% of tea saponin and no less than 1.5% of tannin are set as standard grade products; the content of tea saponin is 10-15%, the tannin content is less than 1.5%, and the tea saponin content is a common grade product; if the tea saponin content is 10% or less, which be regarded as a secondary product).
4. Preparation method comprises the following steps: detecting items of other conventional components (such as crude protein and ash, etc.) and health indexes in a product, and recording the items.
5. After the reexamination is qualified, the label with the corresponding grade is pasted, and then packaged.

The application method of the Tea seed meal product in feed comprises the following steps:

The Tea seed meal standard-grade product (tea saponin content is not less than 15%, the tannin content is not less than 1.5%) is taken as a precondition and a foundation.

According to the biphasic dose effect model of the Tea seed meal Hormesis theory, the dosage range in the low-dose promotion effect of the Tea seed meal is the lowest effective dose (LOEL) from the theory to no visible harmful dose (NOAEL), and the NOAEL value is 10-20 times the LOEL value; the Optimal Dose is one-fifth of the NOAEL value.

In combination with the trial data in the embodiments of the invention, the use amount of the Tea seed meal is added from 250 grams to 4 kilograms of different gradient amounts per ton feed; and 250 grams (see the same LOEL value) to 4 kg (equal to NOAEL value), and the numerical proportion relationship of the two is close to 20 times; the numerical proportion relation is basically consistent with the Hormesis theory; meanwhile, the optimal dosage of the Tea seed meal confirmed by the trial is 1 kg, and the optimal dosage of the Tea seed meal is similar to that of the theoretical optimal dose (NOAEL 5), i.e., 4 kg/5=0.8 kg.

Therefore, the optimal dosage of the Tea seed meal standard product is 0.8-1 kg per ton of feed and the growth effect on livestock and poultry is best. If the Tea seed meal is used for preventing and treating the disease at a certain stage, the short-term dosage of tea seed meal (only for one to two weeks) is added, the suggested dosage of tea seed meal in feed is 2-4 kg per ton feed.

### DETAILED DESCRIPTION OF THE PREFERRED EMBODIMENTS

The following example explains the present invention more concretely, but do not limit the range of the present invention.

### Example 1. Tea Seed Meal Product Preparation Method

The preparation method comprises the following steps of:

1.) Purchasing 20 kg Tea seed meal produced in Zhejiang province, China.

2.) Carrying out mechanical crushing to obtain fine powder of about 120 meshes.

3.) The tea saponin and tannin content in above tea seed meal are detected, the tea saponin is 15.6%, and the tannin content is 1.9%.

4.) Labeling corresponding labels and marking detection/analysis values for later use.

### Example 2. Broiler Growth Performance Trial

Trial design: selecting 1 day age AA broiler 900 with basically consistent size; randomly dividing into six groups, namely one control group and five test groups; each group of 150 birds. Control group (T0) The basic daily ration is fed; and the trial No. 1, 2, 3, 4 and 5 groups are respectively fed with the basic daily ration added the Tea seed meal product got in above embodiment 1, namely 250 g, 500 g, 1 kg, 2 kg, 4 kg/ton, referred to as T 1, T 2, T 3, T 4 and T 5 groups. The broiler chicken adopts a thick cushion material for flat breeding; the day lighting, the temperature and the illumination condition are basically consistent; all the broilers are same feeding and drinking water; and conventional management work is carried out during feeding. The basic daily ration is prepared by reference to the nutrition standard of the AA commodity broiler chicken, and is the corn soybean meal type daily ration and the crude protein 19.5 percent. The Trial period is 42 days, and the Trial results are as follows:

TABLE NO. 1

| | T0 | T1 | T2 | T3 | T4 | T5 |
|---|---|---|---|---|---|---|
| ADG | 50.62 | 51.19 | 52.43 | 53.76 | 51.27 | 50.63 |
| (grams/day) | | | | | | |
| FCR | 1.830 | 1.783 | 1.745 | 1.742 | 1.757 | 1.841 |
| Number of | 9 | 6 | 5 | 3 | 0 | 0 |
| Death | | | | | | |

The Trial results show that the ADG (daily weight gain) and the FCR of the T3 group reach a best level, that is, when the dosage of the Tea seed meal is 1 kg/ton, the effect is best, and the ADG is increased by 6.20% when compared with that of the control group; when the dosage reaches 4 kg/ton, the ADG and the FCR do not change obviously; however, as the dosage of the Tea seed meal is increased, the death number of the chickens is reduced.

### Example 3. Pig Growth Performance Trial

The Trial design is as follows: 120-head healthy piglets are selected, the average body weight is about 15 kg, and piglets are randomly divided into six groups, each group of 20 head piglets. The control group (T0) is fed with basic daily ration; and No. 1, 2, 3, 4, and 5 groups are respectively fed with the basic daily ration added 250 g, 500 g, 1 kg, 2 kg, 4 kg/ton of Tea Seed Meal got in above embodiment 1, referred to as T1, T2, T3, T4 and T5. All trial pigs are same feed and drinking water, fed according to the conventional method, and the trial period is 30 days. The trial results are as follows:

TABLE NO. 2

| | T0 | T1 | T2 | T3 | T4 | T5 |
|---|---|---|---|---|---|---|
| ADG | 510.3 | 514.8 | 529.4 | 536.7 | 519.4 | 503.8 |
| (grams/day) | | | | | | |
| FCR | 2.058 | 2.061 | 1.953 | 1.864 | 1.892 | 2.045 |
| number of | 5 | 4 | 2 | 1 | 0 | 0 |
| diarrhea | | | | | | |

The trial results show that the ADG (Daily Weight Gain) and the FCR of the T3 group reach the best effect, and the ADG is increased by 5.06% when compared with the control group; when the dosage is above 4 kg/ton, the ADG and FCR are both poor, and the daily gain weight and the FCR have no significant difference when compared with control group (T0). However, as the dosage of the Tea seed meal is increased, the number of pig diarrhea is reduced.

The Trial is summarized as follows: when the dosage of the Tea seed meal in the feed is 0.25-1 kg, the daily weight gain and the FCR are improved; When the dosage is increased to 4 kg, although the daily weight gain and the FCR are no obviously improved when compared with the control group (T0), the morbidity is obviously reduced, and this can be due to the fact that active substances such as tea saponin and tannin, flavone and the like contained in the Tea seed meal are increased along with the dosage. The sterilization ability is obviously enhanced, and therefore, the resistance of the animal is obviously enhanced, and the animal is not prone to sick or death. The use amount of the Tea seed meal in feed is preliminarily determined to be within 0.25 to 4 kilograms per ton through the above results, and the usage method is generally beneficial; the usage method also conforms to the low-dose promotion effect model of the Hormesis theory; and Tea seed meal is recommended to be added in feed for a long time, and the optimal dosage is 1 kg per ton. For preventing disease from occurring at a certain period, the usage amount of tea seed meal can be adjusted to 2-3 kg per ton in a short period feeding (such as one to two weeks). If the disease occurs, the addition of 4 kg of tea seed meal can be attempted, and this usage method has positive effect on preventing and treating diseases.

Meanwhile, the production method is simple and easy to operate; Some powdery products of tea seed meal do not need to be processed and can be directly used; The usage and production method disclosed by the invention has zero emission and full utilization, and belongs to green and safe health products; The usage method has the advantages of environment friendliness, ecological friendliness, no pollution discharge, no harmful residue during use, and sustainable development; The feed mill enterprises and farm both get benefit from this invention as Tea seed meal as good and cheap green feed additive, the growth-promoting and disease-prevention effect of Tea seed meal is exactly confirmed. The usage method is easy to popularize, and the advantages of being easy to popularize, capable of directly benefiting for tea growers and tea oil plants, also benefiting for vast farmers, turning waste into wealth, and being beneficial to human being.

The above-described embodiments are merely exemplary embodiments of the invention, and are used to explain the technical solutions and technical effects of the present invention and are not intended to cover all possible embodiments, nor to limit the invention.

The usage method disclosed by the invention has the advantages that technical prejudice of Tea seed meal in the feed industry are corrected, the Hormesis model is adopted, namely a low-dose promotion effect is adopted.

The belief of the tea seed meal is toxic and cannot be used in feed was thoroughly corrected, and a science-based concept is built that Tea seed meal as feed additive is beneficial at low dosage (the preferred dosage is 0.8-1 kg per ton feed). According to the invention of tea seed meal as feed additive, within the scope of the protection of the present invention (0.25 to 4 kg), any simple modifications and changes made to the present invention, such as addition of carrier dilution and the like, fall within the scope of the present invention protection.

At the same time, based on the embodiments of the invention and the direct obvious motivation, a person of ordinary skill in the art, on the premise of not making an inventive effort, defines the use dosage of the Tea seed meal as feed additive from 0.25 to 4 kilograms per ton of complete feed, and extends from the chicken and the pig feed to other single-stomach animal feed, such as ducks, turkeys, quails, birds and pigeons. The poultry includes corresponding meat poultry, laying-egg poultry and breeding birds, and pets (including dog and cats). In addition, other embodiments obtained by other equivalent or equivalent simple alternatives methods are all within the scope of protection of our invention.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed. To the extent a definition of a term set out in a document incorporated herein by reference conflicts with the definition of a term explicitly defined herein, the definition set out herein controls.

1-10. (canceled)

11. A method comprising administering a feed additive to a monogastric animal, wherein the feed additive comprises tea seed meal.

12. The method according to claim 11, wherein the tea seed meal is administered at the amount of 0.25-4 kg per ton of complete feed.

13. The method according to claim 11, wherein the tea seed meal is administered at the amount of 0.5-2 kg per ton of complete feed.

14. The method according to claim 11, wherein the tea seed meal is administered at the amount of 0.8-1 kg per ton of complete feed.

15. The method according to claim 11, wherein the monogastric animal comprises a bird, a pig, a dog, or a cat and the bird comprises a chickens, a duck, a turkey, a quail, or a pigeon.

16. The method according to claim 11, wherein:
the tea seed meal comprises a byproduct of oil-extracted Camellia plant seeds;
the tea seed meal is not subjected to any processing for detoxification purposes; and
the Camellia plant seeds comprises Camellia oleifera seeds, tea leaf seeds, or a combination thereof.

17. The method according to claim 11, wherein the tea seed meal comprises tea saponin at the amount of 8-25 wt %.

18. The method according to claim 11, wherein the tea seed meal comprises tannin at the amount of 0.5-7 wt %.

19. The method according to claim 11, wherein the active ingredients of the Tea seed meal comprises tea saponin, tannin, tea polyphenol, flavonoid compounds, and ceramide.

20. The method according to claim 11, wherein the tea seed meal is in a grass, grassless, powder, granular, or cake-like form.

21. A method comprising administering a feed additive to an animal, wherein the feed additive comprises tea seed meal.

22. The method according to claim 21, wherein the tea seed meal is administered at the amount of 0.25-4 kg per ton of complete feed.

23. The method according to claim 21, wherein the tea seed meal is administered at the amount of 0.5-2 kg per ton of complete feed.

24. The method according to claim 21, wherein the tea seed meal is administered at the amount of 0.8-1 kg per ton of complete feed.
